(19) United States
(12) Patent Application Publication
(10) Pub. No.: US 2026/0298779 A1
(43) Pub. Date: Oct. 1, 2026

(54) SPECIMEN TESTING PLATE STRUCTURE, SPECIMEN TESTING APPARATUS, AND SPECIMEN TESTING METHOD

(71) Applicant: CANON KABUSHIKI KAISHA, Tokyo (JP)

(72) Inventors: YUKIO FURUKAWA, Kanagawa (JP); SO AIZAWA, Kanagawa (JP)

(21) Appl. No.: 19/574,712

(22) Filed: Mar. 23, 2026

(30) Foreign Application Priority Data
Mar. 31, 2025 (JP) 2025-058636

(51) Int. Cl. G01N 1/38; G01N 21/03

(52) U.S. Cl. CPC G01N 1/38; G01N 21/0303

(57) ABSTRACT

Provided is a specimen testing plate structure including a first plate and a second plate provided to face the first plate with a gap therebetween. A first main surface, which exists on a first plate side, out of main surfaces of the second plate includes: a hydrophilic region; and a hydrophobic region. The hydrophilic region includes: a first hydrophilic region of a region free of facing the first plate; and a second hydrophilic region of a region facing the first plate. The hydrophobic region includes: a first hydrophobic region of the region free of facing the first plate; and a second hydrophobic region of the region facing the first plate. A ratio of the second hydrophilic region to the second hydrophobic region and the second hydrophilic region is higher than a ratio of the first hydrophilic region to the first hydrophobic region and the first hydrophilic region.

### BACKGROUND

### Field of the Technology

The present disclosure relates to a specimen testing plate structure that holds a liquid specimen or a reagent, a specimen testing apparatus, and a specimen testing method.

### Description of the Related Art.

In an automatic analysis apparatus that optically measures a concentration, an activity value, or the like of a component contained in a specimen such as blood or urine by utilizing a chemical reaction with a test reagent, the specimen and the test reagent are dispensed into a reaction vessel to measure optical data such as absorbance, and the concentration of the component to be measured is calculated. An optically transparent rectangular reaction cell is used as the reaction vessel because it is suitable that an optical path length be constant without fluctuating depending on the location in the measurement of optical data. It is possible to reduce the amount of reagent consumption by reducing the size of the reaction cell, but on the other hand, there are problems such as the reaction cell being expensive, being difficult to wash or dry, and being difficult to handle.

In U.S. Patent Application Publication No. 2005/0242394, there is disclosed a technology for transporting a droplet in a downstream direction by continuously increasing the ratio of a hydrophilic surface from upstream toward downstream in a plate having a hydrophilic surface pattern and a hydrophobic surface pattern as a pattern forming base material. In addition, in Japanese Patent Laid-Open No. 2005-744, there is disclosed a technology in which a pattern in which the ratio of a hydrophilic surface is continuously increased is formed between a substrate and a cover, a supply port for supplying a droplet is formed in the cover on the upstream side, and the supplied droplet is transported in the downstream direction.

### SUMMARY

According to a first aspect of the present disclosure, there is provided a specimen testing plate structure including: a first plate; and a second plate provided to face the first plate with a gap therebetween. A first main surface, which exists on a first plate side, out of main surfaces of the second plate includes: a hydrophilic region; and a hydrophobic region adjacent to the hydrophilic region. The hydrophilic region includes: a first hydrophilic region included in a region, free of facing the first plate, of the first main surface; and a second hydrophilic region included in a region, facing the first plate, of the first main surface. The hydrophobic region includes: a first hydrophobic region included in the region free of facing the first plate; and a second hydrophobic region included in the region facing the first plate. A ratio of the second hydrophilic region to the second hydrophobic region is higher than a ratio of the first hydrophilic region to the first hydrophobic region.

According to a second aspect of the present disclosure, there is provided a specimen testing apparatus including: a light source unit; a light control unit configured to control light from the light source unit; a light detection unit; and a holding unit for the above-mentioned specimen testing plate structure.

According to a third aspect of the present disclosure, there is provided a specimen testing method of performing testing by irradiating a droplet of a specimen liquid existing inside a specimen testing plate structure with light from a light source, the method including: arranging the droplet on the specimen testing plate structure, and moving the droplet inside the specimen testing plate structure; and irradiating a position of the droplet after the moving in the specimen testing plate structure with light from a light source unit to detect light from the droplet.

Features of the present disclosure will become apparent from the following description of embodiments with reference to the attached drawings. The following description of embodiments is described by way of example.

### BRIEF DESCRIPTION OF THE DRAWINGS

FIGS. 1A, 1B, 1C, and 1D are views for illustrating configurations of a specimen testing plate structure according to this embodiment. FIG. 1A is a schematic view of a surface, facing a first main surface of a second plate, out of surfaces of a first plate. FIG. 1B is a schematic view of a main surface of the second plate. FIG. 1C is a top view of the specimen testing plate structure in which the first plate and the second plate are combined. FIG. 1D is a side view of the specimen testing plate structure in which the first plate and the second plate are combined (a sectional view taken along the line A-A′ in FIG. 1B).

FIGS. 2A, 2B, 2C, 2D and 2E are schematic views for illustrating behavior of a droplet in a specimen testing plate structure according to Example 1. FIG. 2A is a sectional view taken along the line A-A′ in FIG. 1B, from which illustration of a position changing unit is omitted. FIG. 2B is a schematic view of a state at the time when a droplet is dispensed. FIG. 2C is a schematic view of a state at the time when a droplet is dispensed. FIG. 2D is a schematic view of a state at the time when a droplet comes into contact with the first plate. FIG. 2E is a schematic view of a state in which a droplet is stored in a region formed between plates (hereinafter referred to as "droplet holding region").

FIGS. 3A, 3B, 3C, 3D and 3E are explanatory views for illustrating storage of two droplets in a specimen testing plate structure according to Example 2. FIG. 3A is a sectional view taken along the line A-A′ in FIG. 1B for illustrating a state in which one droplet has been already stored, and a schematic view from which illustration of a position changing unit is omitted. FIG. 3B is a schematic view of a state at the time when a second droplet is dispensed. FIG. 3C is a schematic view of a state at the time when a second droplet is dispensed. FIG. 3D is a schematic view of a state at the time when the second droplet comes into contact with the first plate. FIG. 3E is a schematic view of a state in which the second droplet is stored in a droplet holding region.

FIGS. 4A, 4B, 4C, 4D and 4E are explanatory views for illustrating stirring of two droplets in a specimen testing plate structure according to Example 3. FIG. 4A is a sectional view taken along the line A-A′ in FIG. 1B for illustrating a state in which one droplet has been already stored, a schematic view from which illustration of a position changing unit is omitted, and a schematic view of a state in which a droplet that is difficult to mix with the already stored droplet is in contact with the first plate. FIG. 4B is a schematic view for illustrating a state of a mixed liquid. FIG. 4C is a schematic view of a state in a case in which relative positions of the first plate and the second plate are changed. FIG. 4D is a schematic view of a state in a case in which the relative positions of the first plate and the second plate are changed. FIG. 4E is a schematic view of a state in which the mixed liquid is mixed.

FIGS. 5A, 5B and 5C are views for illustrating configurations of a specimen testing plate structure according to Example 4. FIG. 5A is a schematic view of a surface of a first plate facing a main surface of a second plate. FIG. 5B is a side view of the first plate. FIG. 5C is a side view of a state in which the first plate and the second plate are combined.

FIGS. 6A and 6B are views for illustrating behavior of a droplet in a specimen testing plate structure according to Example 4. FIG. 6A is a sectional view of a state at the time when a droplet comes into contact with an edge portion of the first plate. FIG. 6B is a sectional view of a state in which the droplet is stored in a holding region.

FIGS. 7A, 7B, 7C, 7D and 7E are schematic views for illustrating configurations of a surface of a first plate facing a main surface of a second plate in a specimen testing plate structure according to Example 5. FIG. 7A is a schematic view related to a plate used in Examples 1 to 4. FIG. 7B is a schematic view related to a different embodiment. FIG. 7C is a schematic view related to a different embodiment. FIG. 7D is a schematic view related to a different embodiment. FIG. 7E is a schematic view related to a different embodiment.

FIGS. 8A, 8B and 8C are views for illustrating configurations of a specimen testing plate structure in which hydrophilic regions are arranged in a one-dimensional manner in a specimen testing plate structure according to Example 6. FIG. 8A is a schematic view of the second plate. FIG. 8B is a schematic view of one main surface of the first plate. FIG. 8C is a top view of the specimen testing plate structure in which the second plate and the first plate are combined.

FIG. 9 is a top view of a specimen testing plate structure in which hydrophilic regions are arranged in a two-dimensional manner in a specimen testing plate structure according to Example 7.

### DESCRIPTION OF THE EMBODIMENTS

An example of at least one embodiment of the present disclosure is described.

A specimen testing plate structure according to this embodiment relates to a specimen testing plate structure including a first plate and a second plate provided to face the first plate with a gap therebetween. A first main surface, which exists on a first plate side, out of main surfaces of the second plate includes a hydrophilic region, and a hydrophobic region adjacent to the hydrophilic region. The hydrophilic region includes: a first hydrophilic region included in a region, free of facing the first plate, of the first main surface; and a second hydrophilic region included in a region, facing the first plate, of the first main surface. The hydrophobic region includes: a first hydrophobic region included in the region free of facing the first plate; and a second hydrophobic region included in the region facing the first plate. A ratio of the second hydrophilic region to the second hydrophobic region and the second hydrophilic region is higher than a ratio of the first hydrophilic region to the first hydrophobic region and the first hydrophilic region. The expression "the ratio of the second hydrophilic region to the second hydrophobic region and the second hydrophilic region is higher than the ratio of the first hydrophilic region to the first hydrophobic region and the first hydrophilic region" as used herein may mean that "the ratio of the second hydrophilic region to the second hydrophobic region is higher than the ratio of the first hydrophilic region to the first hydrophobic region".

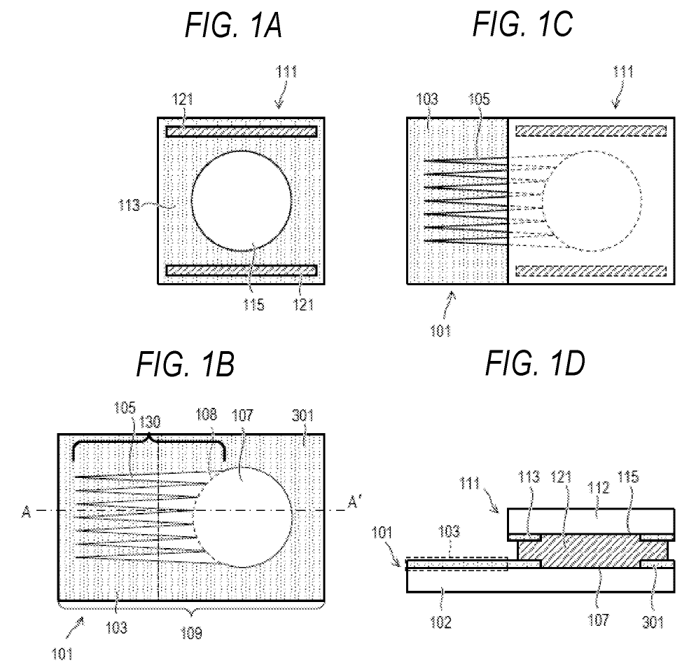

The specimen testing plate structure according to this embodiment is described with reference to FIGS. 1A-1D.

The specimen testing plate structure has a second plate 101 at a position facing a first plate 111 with a gap from the first plate 111.

### First Plate

FIG. 1A is a schematic view of a surface of the first plate 111 facing a main surface of the second plate 101. The term "facing" as used herein means being opposed to each other, and the surfaces may face each other in a parallel manner or may face each other in a non-parallel manner. A base material 112 of the first plate 111 includes, for example, glass or resin. This is because it is desirable to be transparent, for example, to have a transmittance of 80% or more, with respect to a wavelength of light from a light source used for obtaining optical data for specimen testing. A hydrophobic region 113 of the first plate 111 is formed on one surface (one main surface) of the first plate 111. Further, part of the hydrophobic region 113 of the first plate 111 exists in a circular shape around a hydrophilic region 115 of the first plate 111. Here, the terms "hydrophilicity" and "hydrophobicity" as used in this embodiment can be defined by, for example, an angle of a boundary surface between a liquid and a solid (contact angle of water) at a point with which a water droplet is in contact at the time when the water droplet is placed on a solid surface. For example, the hydrophilic region can be defined as a region in which the contact angle of water is 70° or less, the hydrophobic region can be defined as a region in which the contact angle of water is 70° or more, and a difference in the contact angle of water between the hydrophilic region and the hydrophobic region is preferably 50° or more. The hydrophilic region 115 of the first plate 111 may be formed by forming a hydrophilic film, or the surface of glass or resin being the base material may be used. The hydrophobic region 113 of the first plate 111 is suitably a fluorine-based resin such as Teflon (trademark) resin. For example, when Teflon (trademark) resin is used, the contact angle with respect to water is about 110°. On the other hand, the contact angle with respect to water is from about 10° to about 20° on a glass surface. A position changing unit 121 allows changing a relative position between the first plate and the second plate, and is used to form a predetermined gap at the time of combining the first plate 111 with the second plate 101 to be described later. Further, as described later, in order to allow the position of the first plate to be moved relative to the second plate 101, the position changing unit 121 is a spacer and may be an elastic body such as rubber (Young's modulus of from 0.01 GPa to 0.1 GPa). As long as, statically, the gap between the first plate 111 and the second plate 101 returns to the original state, and the gap can fluctuate when an external force is applied, the material is not limited to rubber, and may any material that structurally achieves such a function.

### Second Plate

FIG. 1B is a schematic view of the second plate 101. A base material 102 of the second plate 101 is formed of, for example, glass or resin, similarly to the first plate 111. It is desirable to be transparent, for example, to have a transmittance of 80% or more, with respect to the wavelength of light used for obtaining optical data for specimen testing. A hydrophobic region is formed on one surface of the second plate 101 (a main surface on the first plate side out of main surfaces of the second plate 101). The hydrophobic region includes a first hydrophobic region 103 included in a region free of facing the first plate, and a second hydrophobic region 301 included in a region facing the first plate.

A hydrophilic region is formed on one surface of the second plate 101 (the main surface on the first plate side out of the main surfaces of the second plate 101). The hydrophilic region includes a first hydrophilic region 105 included in the region free of facing the first plate, and a second hydrophilic region 107 included in the region facing the first plate.

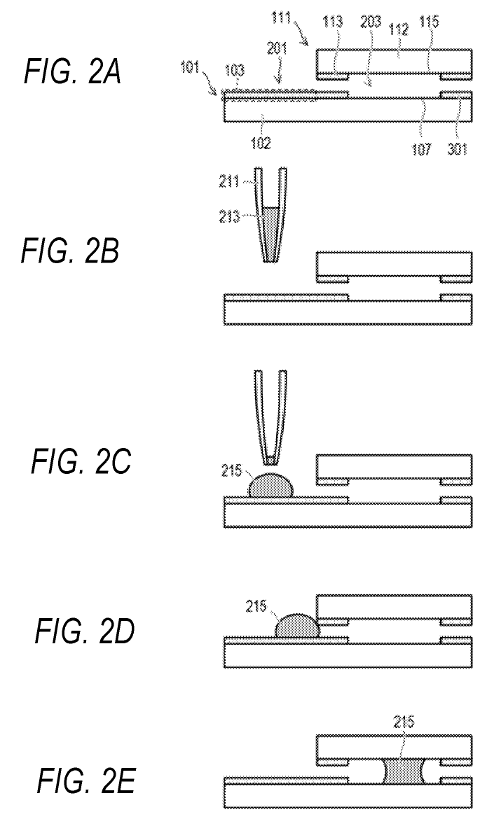

Further, it is preferred that at least part of the hydrophobic region exist around the hydrophilic region. In FIG. 1B, part of the second hydrophobic region 301 surrounds the second hydrophilic region 107. A space above the second hydrophilic region 107 is a droplet holding region 203 (see FIG. 2A). Further, a hydrophilic region 130 including part of the second hydrophilic region 107 and the first hydrophilic region 105 has a comb-teeth shape. It is preferred that the second hydrophilic region 107 and the hydrophilic region 130 having a comb-teeth shape be continuous. The first hydrophilic region 105 exists in a region, free of facing the first plate 111, of the first main surface 109, and a ratio of the second hydrophilic region 107 to the second hydrophobic region 301 is larger than a ratio of the first hydrophilic region 105 to the first hydrophobic region 103. Preferably, in a direction from the region free of facing the first plate toward the region facing the first plate on the first main surface, the ratio of the hydrophilic region to the hydrophobic region increases (in other words, the area of the hydrophilic region increases with respect to the areas of the hydrophobic region and the hydrophilic region). In the direction from the region free of facing the first plate toward the region facing the first plate on the first main surface, the ratio of the hydrophilic region to the hydrophobic region and the hydrophilic region (the size of the hydrophilic region with respect to the size of the hydrophobic region and the hydrophilic region) may increase stepwise (including two steps) or may increase continuously. The second hydrophilic region may have a circular region (108). At least one of the second hydrophilic region 107 or the first hydrophilic region 105 may be formed by forming a hydrophilic film, or the surface of glass or resin being the base material may be used. At least one of the first hydrophobic region 103 or the second hydrophobic region 301 is suitably a hydrophobic film formed of Teflon (trademark) resin or a fluorine-based resin. For example, when Teflon (trademark) resin is used, the contact angle with respect to water is about 110°. On the other hand, the contact angle with respect to water is from about 10° to about 20° on the glass surface.

### Combination of First Plate and Second Plate

FIG. 1C is a top view of a state in which the first plate 111 and the second plate 101 are combined, and FIG. 1D is a side view of the state in which the first plate 111 and the second plate 101 are combined (a sectional view taken along the line A-A′ in FIG. 1B). The first plate 111 and the second plate 101 are combined via the position changing unit 121 so that the hydrophobic region 113 of the first plate 111 and the second hydrophobic region 301 face each other, and the hydrophilic region 115 of the first plate 111 and the second hydrophilic region 107 of the second plate 101 vertically matches (faces) each other. The first hydrophobic region 103 of the second plate 101 is schematically illustrated surrounded by a dotted line. Further, as illustrated in FIG. 1C, the first hydrophilic region 105 exists at a position, free of facing the first plate 111, on the main surface (entire region illustrated in FIG. 1D) of the second plate 101, and is exposed when viewed from above. As described later, a droplet is dispensed to an exposed portion including the first hydrophilic region 105 (a portion of the second plate 101 free of facing the first plate 111). The structure is not limited thereto as long as the droplet can be dispensed to the portion including the first hydrophilic region 105, and for example, a window for dispensing may be provided in the first plate 111.

The configuration of the specimen testing plate structure according to the present disclosure is as described above.

More detailed configurations and effects thereof become apparent in the following Examples.

### Specimen Testing Apparatus

Further, a specimen testing apparatus according to this embodiment relates to a specimen testing apparatus including a light source unit, a light control unit that controls light from the light source unit, a light detection unit, and a holding unit for the above-mentioned specimen testing plate structure. In the specimen testing apparatus, it is preferred that the light control unit be a light control unit that performs control to irradiate the second hydrophilic region of the above-mentioned specimen testing plate structure held by the holding unit with light from the light source unit.

### Specimen Testing Method

Further, a specimen testing method according to this embodiment relates to a specimen testing method of performing testing by irradiating a droplet of a specimen liquid existing inside a specimen testing plate structure with light from a light source, the method including: arranging the droplet on the specimen testing plate structure, and moving the droplet inside the specimen testing plate structure; and irradiating a position of the droplet after moving in the specimen testing plate structure with light from a light source unit to detect light from the droplet.

Further, in the specimen testing method according to this embodiment, it is preferred that the specimen testing plate structure be the specimen testing plate structure according to this embodiment described above.

### Example 1

A more specific example of the behavior of the droplet in the specimen testing plate structure according to this embodiment is described with reference to FIGS. 2A to 2E. FIG. 2A is a sectional view taken along the line A-A′, similarly to FIG. 1D. Here, illustration of the position changing unit 121 is omitted to simplify the description. In the figure, a dispensing region 201 includes the first hydrophilic region 105, and a droplet holding region 203 is surrounded by the hydrophilic region 115 of the first plate and the second hydrophilic region 107 of the second plate.

The base material 112 of the first plate 111 and the base material 102 of the second plate 101 are, for example, quartz glass having a thickness of 1 mm. The position changing unit 121 (not shown) is a spacer made of, for example, rubber having a height of 1 mm, and is configured such that a gap is set to 1 mm under a state in which the first plate 111 and the second plate 101 are combined. The hydrophobic region 113 (second hydrophobic region) of the first plate 111 and the hydrophobic region 103 (first hydrophobic region) of the second plate 101 are Teflon (trademark) resin having a thickness of 15 microns. The contact angle with respect to water is 15° in the hydrophilic region 115 of the first plate 111 and the second hydrophilic region 107 of the second plate 101, and is 110° in the hydrophobic region 113 of the first plate 111 and the hydrophobic region 103 of the second plate 101.

The hydrophilic region 115 of the first plate 111 and the second hydrophilic region 107 of the second plate 101 were circular with a diameter of 4 mm. As a result, a volume of the droplet holding region 203 is 12.6 μL assuming a cylinder.

FIGS. 2B and 2C show the state of dispensing. In the figures, a pipette tip 211 is illustrated, and a testing liquid 213 includes a mixed liquid of a glucose solution (specimen substitute liquid) prepared at a predetermined concentration and a commercially available glucose coloring liquid. As illustrated in FIG. 2C, one droplet 215 having a volume of 5 μL is dispensed to the exposed portion of the dispensing region 201. The second plate 101 includes the first hydrophilic region 105 (not shown). A ratio of the hydrophilic region to the hydrophobic region and the hydrophilic region is different between the right side and the left side of the droplet 215, and the ratio of the hydrophilic region is higher on the right side. As a result, a rightward force is generated in the droplet 215, and the droplet 215 moves to the right side.

When the droplet 215 that has moved to the right side comes into contact with the adjacent first plate 111 as illustrated in FIG. 2D, a capillary force is generated, and the droplet is drawn into a constricted portion defined by the first plate 111 and the second plate 101. As a result, as illustrated in FIG. 2E, the droplet 215 is stored in the droplet holding region 203.

A glucose concentration of the glucose solution (specimen substitute liquid) can be measured by irradiating the droplet 215 with light of a predetermined wavelength, and measuring absorbance from the droplet held in the droplet holding region 203. For example, a measurement method generally called an end-point method can be used. Specifically, about 5 minutes after mixing, light having a wavelength of 505 nm is applied to measure the absorbance, and the glucose concentration of the glucose solution (specimen substitute liquid) is calculated from a mixing ratio of the glucose solution (specimen substitute liquid) and the glucose coloring liquid. At this time, an optical path length is set to 1 mm by the position changing unit 121, and hence the absorbance of the droplet 215 can be measured with high accuracy. Further, even when the volume of the droplet deviates from a predetermined value, the optical path length is unchanged, and thus measurement accuracy is not affected. In addition, volume fluctuation due to evaporation of the droplet during a reaction time can be suppressed by being covered with the first plate 111.

### Comparative Example

Comparative Example is a structure in which the first plate 111 of the specimen testing plate structure of Example 1 is not provided. When the first plate 111 is not provided, the droplet has a spherical cap shape (a shape in which a part of a sphere is cut off), and the optical path length varies depending on the location. As a result, it is difficult to perform accurate absorbance measurement. Further, when the volume of the droplet deviates from a predetermined value, a height of the spherical cap changes, and measurement accuracy is affected. In addition, a concentration may change due to volume fluctuation caused by droplet evaporation during the reaction time.

As described above, according to the specimen testing plate structure of this embodiment, a small amount of a testing liquid of about several μL can be stored in the holding region without applying special power. Further, the optical path length can be defined to a predetermined value, and hence accuracy of optical data is improved.

Further, when an optically transparent rectangular reaction cell as described in the "Description of the Related Art" section is used as a general-purpose vessel, a reagent amount of from about 50 μL to about 100 μL is required, but in this example, the reagent amount is about 5 μL, and hence it is possible to reduce consumption of the reagent.

### Example 2

In Example 1, the example in which one droplet is stored in the droplet holding region 203 has been given, but the volume of the droplet holding region may be determined so that at least two or more droplets can be held. Accordingly, in this Example, an example in which two droplets are stored in the droplet holding region 203 is described.

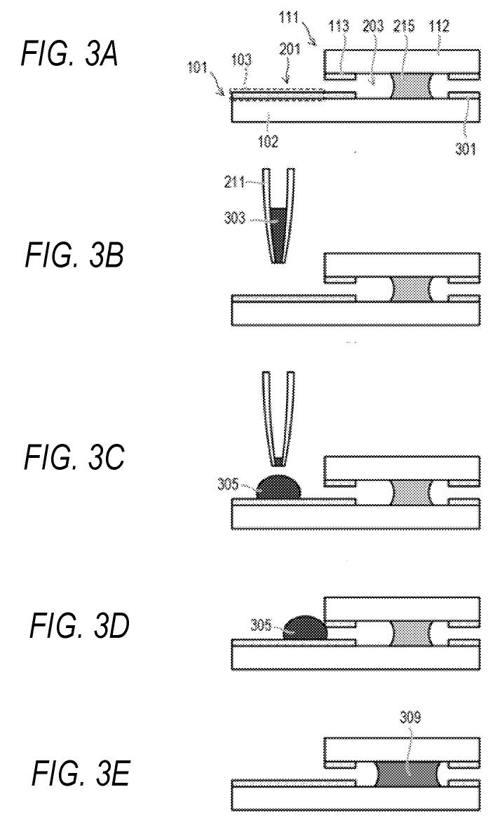

Storage of two droplets in the specimen testing plate structure according to this Example is described with reference to FIGS. 3A to 3E. FIG. 3A is a sectional view taken along the line A-A′, similarly to FIG. 2A. Here, illustration of the position changing unit 121 is omitted to simplify the description. The same members are denoted by the same reference numerals, and description thereof is omitted.

In FIG. 3A, a droplet 215 includes a mixed liquid in which mouse serum and a buffer solution are mixed at a predetermined ratio, and has a volume of 5 μL. A method of storing the droplet 215 in the droplet holding region 203 is similar to that described in Example 1.

FIGS. 3B and 3C show a state of dispensing a second droplet. A commercially available substrate solution 303 for lipase activity measurement is illustrated. As illustrated in FIG. 3C, a droplet 305 having a volume of 5 μL is dispensed to the dispensing region 201. Similarly to Example 1, a difference in the ratio of the hydrophilic region to "the hydrophobic region and the hydrophilic region" between a region in which the second droplet is dispensed (dropped) and a plurality of adjacent regions on the left and right becomes a driving force, and a rightward force is generated in the droplet 305 in the dispensing region 201, and the droplet moves to the right side.

When the droplet 305 that has moved to the right side comes into contact with the first plate 111 as illustrated in FIG. 3D, a capillary force is generated, and the droplet is drawn into a constricted portion defined by the first plate 111 and the second plate 101. As a result, as illustrated in FIG. 3E, a droplet 309 formed by mixing the droplet 215 and the droplet 305 is stored in the droplet holding region 203. A capillary force for a microdroplet is strong, and hence the microdroplet is instantaneously drawn into the constricted portion. As a result, mixing is performed by an impact at the time when two droplets collide.

A lipase concentration of the mouse serum can be measured by irradiating the droplet 309 with light of a predetermined wavelength, and measuring the absorbance thereof. For example, a measurement method generally called a rate method can be used. Specifically, light having a wavelength of 580 nm is applied to measure absorbance every 20 seconds for 5 minutes immediately after mixing, and an increase (slope) in the absorbance is calculated. Then, the lipase concentration of the mouse serum is calculated in consideration of mixing ratios of various solutions. At this time, the optical path length is set to 1 mm by the position changing unit 121, and hence the absorbance of the droplet 215 can be measured with high accuracy. In addition, volume fluctuation due to evaporation of the droplet during the reaction time can be suppressed by being covered with the first plate.

In this Example, the example in which two droplets are stored in the droplet holding region has been given, but the configuration is not limited thereto. For example, three droplets including mouse serum, a buffer solution, and a substrate solution may be stored in the droplet holding region.

### Example 3

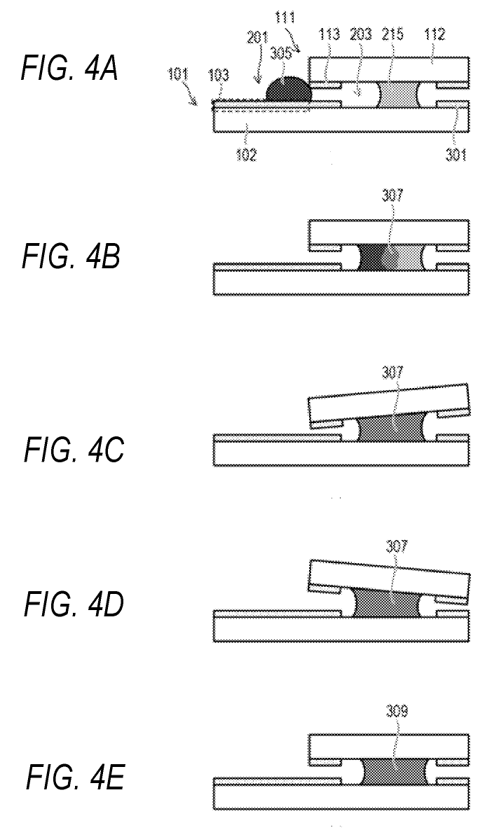

In Example 2, the example in which mixing is performed by an impact at the time when two droplets collide has been given, but it is also possible to improve measurement accuracy by more actively promoting mixing for droplets that are difficult to mix. An example thereof is illustrated in FIGS. 4A to 4E.

FIG. 4A shows a state in which the droplet 305 that has moved to the right side is in contact with the first plate 111, which is the same as in FIG. 3D. In this state, a capillary force is generated, and the droplet 305 is drawn into a constricted portion between plates defined by the first plate 111 and the second plate 101, and the droplet 215 and the droplet 305 collide to form a mixed liquid 307 as illustrated in FIG. 4B. In FIG. 4B, a state in which the two liquids are mixed in the center but are not mixed in the periphery is schematically expressed by gradation.

In addition, stirring is promoted by changing a distance (relative position) between the first plate 111 and the second plate 101 by pushing or pulling an end of the first plate 111 as illustrated in FIGS. 4C and 4D. Although not shown, such an operation is enabled because the position changing unit 121 is a spacer and is an elastic body such as rubber. As a result, as illustrated in FIG. 4E, a mixed droplet 309 is formed and stored in the droplet holding region 203.

In this Example, improvement in measurement accuracy can be expected because uniformity of the droplet is improved and in-plane variation of optical data becomes smaller as compared to Example 2. In this Example, the example in which the first plate is tilted with respect to the second plate has been given, but the configuration is not limited thereto. The distance between the first plate and the second plate may be varied while maintaining the first plate and the second plate parallel to each other.

### Example 4

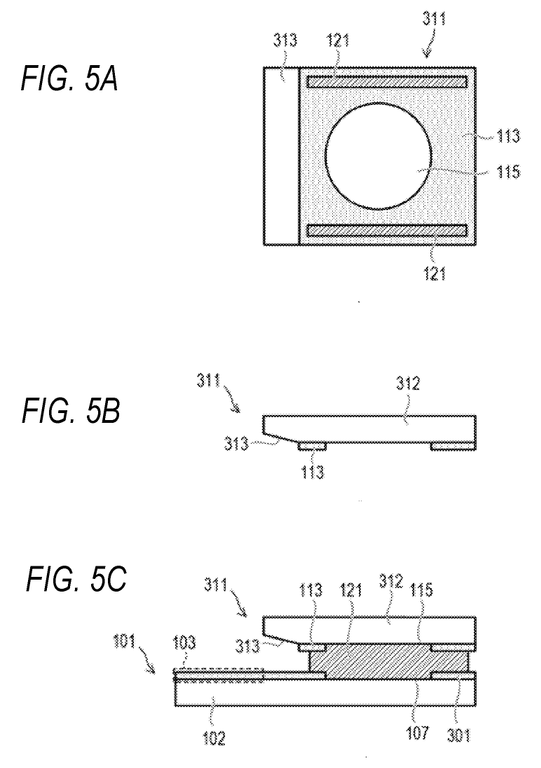

In Examples 1 to 3, depending on viscosity of a droplet and a shape of an edge portion of a first plate, there is a case in which the droplet is trapped at the edge portion of the first plate, and thus is not drawn into a constricted portion. A structure for avoiding such a phenomenon is described with reference to FIGS. 5A to 5C. In the figures, the same members as those described above are denoted by the same reference numerals, and description thereof is omitted.

FIG. 5A is a schematic view of a main surface of a first plate 311 facing a first main surface of a second plate 101 in this Example, and FIG. 5B is a side view of the first plate 311. Unlike Examples 1 to 3, in this Example, a tapered portion 313 is formed at a portion at which a droplet first comes into contact (droplet arrangement portion) in a base material 312. The tapered portion can also be referred to as "tapered shape".

FIG. 5C is a side view of a state in which the first plate 311 and the second plate 101 are combined.

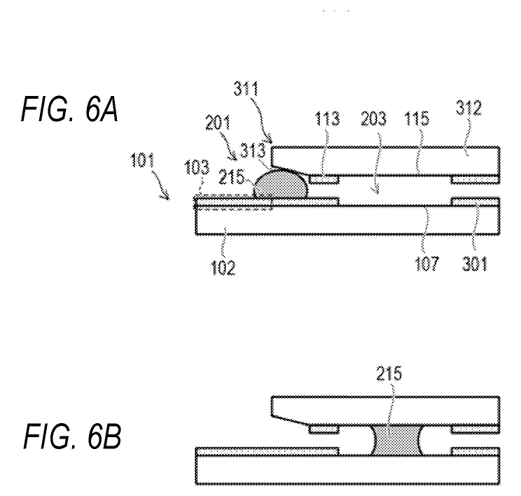

Behavior of a droplet in a specimen testing plate structure according to this Example is described with reference to FIGS. 6A and 6B.

FIG. 6A shows a state in which a dispensed droplet 215 has moved to the right and has come into contact with the first plate 311. Under this state, a capillary force is generated toward a direction in which a gap is narrower, and accordingly the droplet 215 moves to the right. As a result, as illustrated in FIG. 6B, the droplet 215 is stored in a droplet holding region 203.

According to this Example, with frequency of failure in drawing in a droplet being reduced, it is possible to more reliably store a droplet in a droplet holding region.

### Example 5

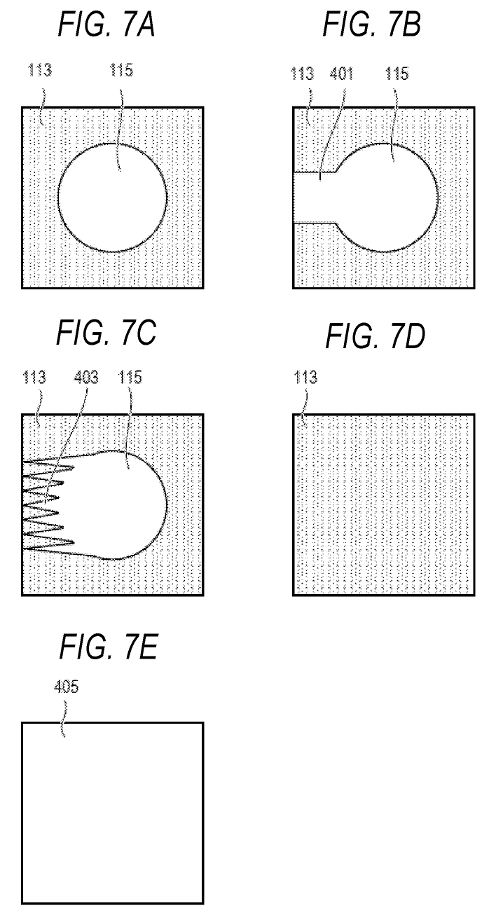

In Examples 1 to 4, the configuration in which the circular hydrophilic region 115 of a first plate is surrounded by the hydrophobic region 113 of the first plate has been described, but the configuration is not limited thereto. Other examples of the first plate are described with reference to FIGS. 7A to 7E.

FIG. 7A: Same as Examples 1 to 4.

FIG. 7B: A hydrophilic region 115 of a first plate has a shape formed of a circular portion and a hydrophilic region 401 connecting an edge with which a droplet first comes into contact and the circular portion. This configuration has an effect of more effectively drawing a droplet into a holding region.

FIG. 7C: A hydrophilic region 115 of a first plate has a shape formed of a circular portion and a region 403 having a comb-teeth shape and connecting an edge with which a droplet first comes into contact and the circular portion. This configuration has an effect of more effectively drawing a droplet into a holding region.

FIG. 7D: The entire surface is covered with a hydrophobic region 113 of a first plate. A droplet holding region is formed as a second hydrophilic region on a second plate side. In this example, reduction in manufacturing cost can be expected.

FIG. 7E: The entire surface is covered with a hydrophilic region 405 of a base material surface. A droplet holding region is formed as a second hydrophilic region on a second plate side. In this example, reduction in manufacturing cost can be expected.

### Example 6

The example in which one droplet holding region is provided has been given in Examples described above, but a plurality of droplet holding regions may be arranged in an array.

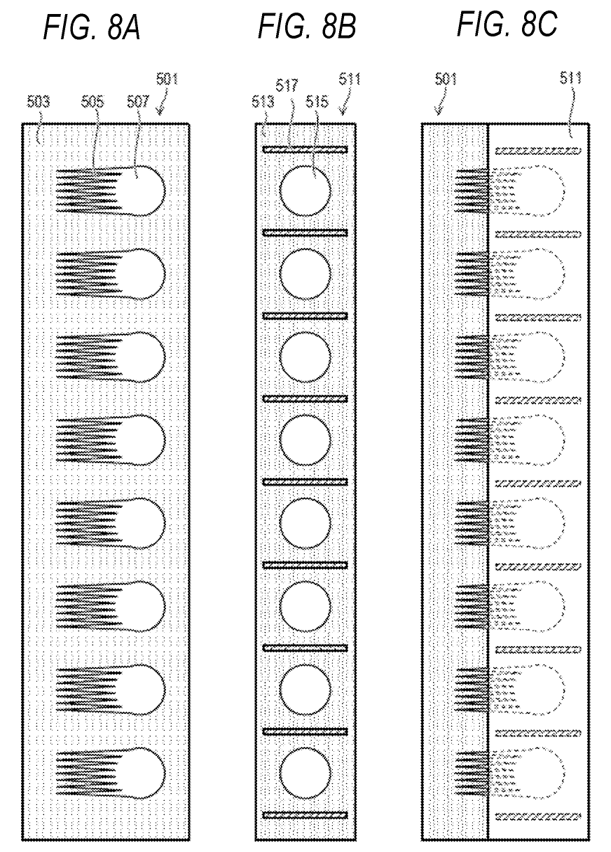

FIGS. 8A to 8C show an example in which droplet holding regions are arranged in a one-dimensional manner. An example in which eight droplet holding regions are arranged in one row is illustrated here.

FIG. 8A is a schematic view of a second plate 501. In the figure, a hydrophobic region 503 is illustrated, and eight hydrophilic patterns each including a second hydrophilic region 507 and a first hydrophilic region 505 are arranged in one row.

FIG. 8B is a schematic view of a first plate 511. In the figure, a hydrophobic portion 513 of the first plate is illustrated, and eight hydrophilic regions 515 of the first plate are arranged in one row. Spacers 517 each formed of an elastic body are illustrated, and nine spacers 517 are arranged so as to separate the hydrophilic regions 515 of the first plate.

FIG. 8C is a top view of a state in which the second plate 501 and the first plate 511 are combined.

According to this Example, a large number of droplets can be held in a small area, and hence improvement in throughput and reduction in footprint of an apparatus can be expected.

In this Example, the first plate is formed as a single integrated unit, but may be formed as separate units for each droplet holding region. In this case, stirring can be performed independently for each droplet holding region.

### EXAMPLE 7

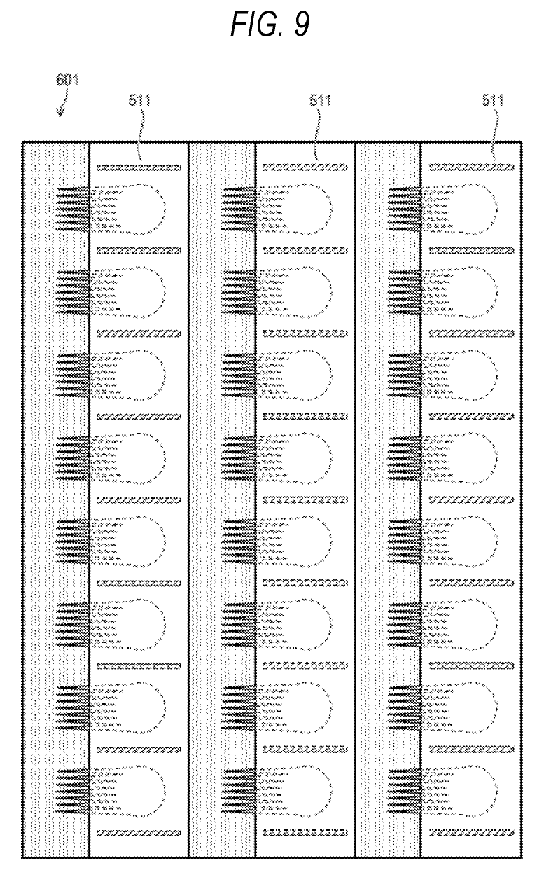

FIG. 9 shows an example in which droplet holding regions are arranged in a two-dimensional direction. An example in which droplet holding regions are arranged in 8×3 is illustrated here.

A second plate 601 is illustrated, in which hydrophilic patterns each including a first hydrophilic region and a second hydrophilic region are arranged in an 8×3 array in a hydrophobic region.

A first plate 511 is illustrated, and has the same configuration as that in Example 6. Three first plates 511 are arranged so as to cover the second hydrophilic regions of the second plate 601 row by row.

According to this Example, a large number of droplets can be held in a small area, and hence improvement in throughput and reduction in footprint of an apparatus can be expected.

In this Example, the first plate is formed as a single integrated unit, but may be formed as separate units for each droplet holding region. In this case, stirring can be performed independently for each droplet holding region.

### Other Examples

In the specimen testing plate structure of this Example, the structure may be disposable in order to avoid contamination for each measurement. Alternatively, the structure may be washed and reused a plurality of times.

As a washing method, a portion of a droplet transport structure and a portion of a droplet holding unit can be washed by dispensing and drawing in a washing liquid of an amount equal to or larger than a volume of a droplet holding region. When drying is required, a constricted portion can be blown off by air blow.

Alternatively, a first plate and a second plate may be configured to be detachable from each other, and may each be washed separately. In this case, an effect that the plates can be easily dried is obtained.

In a case of separating the plates, from a viewpoint of ease of handling, it is preferred that a spacer be integrated with any one of the plates. For example, the first plate and the spacer may be integrated with each other.

In a case of specimen testing, reaction may be performed in an environment at, for example, 37°C by mimicking human body temperature. In such an application, the specimen testing plate structure of the present disclosure may be used on a hot plate kept at a predetermined temperature. At that time, it is also possible to facilitate optical measurement by providing an opening in the hot plate and aligning a portion corresponding to a droplet holding unit of the specimen testing plate structure with the opening.

According to the present disclosure, it is possible to provide a specimen testing plate structure, a specimen testing apparatus, and a specimen testing method, with which specimen testing with a small amount of test reagent or specimen can be expected to be achieved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-058636, filed March 31, 2025, which is hereby incorporated by reference herein in its entirety.

What is claimed is:

1. A specimen testing plate structure comprising:
a first plate; and
a second plate provided to face the first plate with a gap therebetween,
wherein a first main surface, which exists on a first plate side, out of main surfaces of the second plate includes:
a hydrophilic region; and
a hydrophobic region adjacent to the hydrophilic region,
wherein the hydrophilic region includes:
a first hydrophilic region included in a region, free of facing the first plate, of the first main surface; and
a second hydrophilic region included in a region, facing the first plate, of the first main surface,
wherein the hydrophobic region includes:
a first hydrophobic region included in the region free of facing the first plate; and
a second hydrophobic region included in the region facing the first plate, and
wherein a ratio of the second hydrophilic region to the second hydrophobic region and the second hydrophilic region is higher than a ratio of the first hydrophilic region to the first hydrophobic region and the first hydrophilic region.

2. The specimen testing plate structure according to claim 1, wherein a main surface on a second plate side out of main surfaces of the first plate includes a hydrophilic region and a hydrophobic region.

3. The specimen testing plate structure according to claim 2, wherein at least part of the hydrophilic region of the main surface on the second plate side out of the main surfaces of the first plate and at least part of the second hydrophilic region are provided to face each other.

4. The specimen testing plate structure according to claim 1, wherein the hydrophobic region exists around the hydrophilic region of a main surface on a second plate side out of main surfaces of the first plate.

5. The specimen testing plate structure according to claim 1, wherein an end portion of the first plate on a side of the region, free of facing the first plate, of the first main surface has a tapered shape.

6. The specimen testing plate structure according to claim 1, further comprising a position changing unit that allows changing a relative position between the first plate and the second plate.

7. The specimen testing plate structure according to claim 6, wherein the position changing unit is a spacer existing between the first plate and the second plate.

8. The specimen testing plate structure according to claim 7, wherein the spacer is an elastic body.

9. The specimen testing plate structure according to claim 1, wherein the first hydrophilic region includes a region having a comb-teeth shape.

10. The specimen testing plate structure according to claim 1, wherein a ratio of the hydrophilic region to the hydrophobic region and the hydrophilic region increases stepwise in a direction from the region free of facing the first plate toward the region facing the first plate on the first main surface.

11. The specimen testing plate structure according to claim 1, wherein the ratio of the hydrophilic region to the hydrophobic region and the hydrophilic region increases continuously from the region free of facing the first plate to the region facing the first plate on the first main surface.

12. The specimen testing plate structure according to claim 1, wherein the hydrophobic region exists around the hydrophilic region.

13. The specimen testing plate structure according to claim 1, wherein a plurality of hydrophilic regions each having the first hydrophilic region and the second hydrophilic region are arranged in a one-dimensional direction on the first main surface to form the hydrophilic region.

14. The specimen testing plate structure according to claim 1, wherein a plurality of hydrophilic regions each including the first hydrophilic region and the second hydrophilic region are arranged in a two-dimensional direction on the first main surface to form the hydrophilic region.

15. The specimen testing plate structure according to claim 1, further comprising a structure in which the first plate and the second plate are detachable from each other.

16. The specimen testing plate structure according to claim 7, further comprising a structure in which the first plate and the spacer are integrated with each other.

17. A specimen testing apparatus comprising:
a light source unit;
a light control unit configured to control light from the light source unit;
a light detection unit; and
a holding unit for the specimen testing plate structure of claim 1.

18. The specimen testing apparatus according to claim 17, wherein the light control unit is a light control unit configured to perform control to irradiate the second hydrophilic region of the specimen testing plate structure held by the holding unit with light from the light source unit.

19. A specimen testing method of performing testing by irradiating a droplet of a specimen liquid existing inside a specimen testing plate structure with light from a light source, the method comprising:
arranging the droplet on the specimen testing plate structure, and moving the droplet inside the specimen testing plate structure; and
irradiating a position of the droplet after the moving in the specimen testing plate structure with light from a light source unit to detect light from the droplet.

20. The specimen testing method according to claim 19, wherein the specimen testing plate structure is the specimen testing plate structure of claim 1.
